(19) United States
(12) Patent Application Publication
(10) Pub. No.: US 2014/0201559 A1
(43) Pub. Date: Jul. 17, 2014

(54) CONTROL SYSTEM AND METHOD FOR FANS

(71) Applicant: HON HAI PRECISION INDUSTRY CO., LTD., New Taipei (TW)

(72) Inventor: LI-WEN CHANG, New Taipei (TW)

(73) Assignee: HON HAI PRECISION INDUSTRY CO., LTD., New Taipei (TW)

(21) Appl. No.: 14/158,744

(22) Filed: Jan. 17, 2014

(30) Foreign Application Priority Data
Jan. 17, 2013 (TW) 102101853

(51) Int. Cl. G06F 11/30

(52) U.S. Cl. CPC G06F 11/3062
USPC 713/340

(57) ABSTRACT

A control system comprises a power distribution unit (PDU), a number of fan modules, a processing module, and a storage module. The PDU comprises a number of power-output terminals. The storage module comprises a number of programs to be executed by the processing unit. The storage module obtains power information output by the power-output terminals, and obtains corresponding control information from a mapping unit according to the power information. The storage module further generates a pulse width modulation (PWM) signal corresponding to the control information, and outputs the PWM signal to a corresponding fan module.

### BACKGROUND

1. Technical Field

The present disclosure relates to a control system for fans.

2. Description of Related Art

A server cabinet may comprise a plurality of servers, and a number of fans for dissipating heat generated by the servers. A number of temperature sensors are configured to sense a temperature of each server, and rotation speeds of the fans are controlled according to the sensed temperatures. However, temperature sensors are expensive.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of an embodiment of a control system for fans.

FIG. 2 is a block diagram of an embodiment of a main controller of the control system of FIG. 1.

FIG. 3 is flowchart of an embodiment of a control method for fans.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

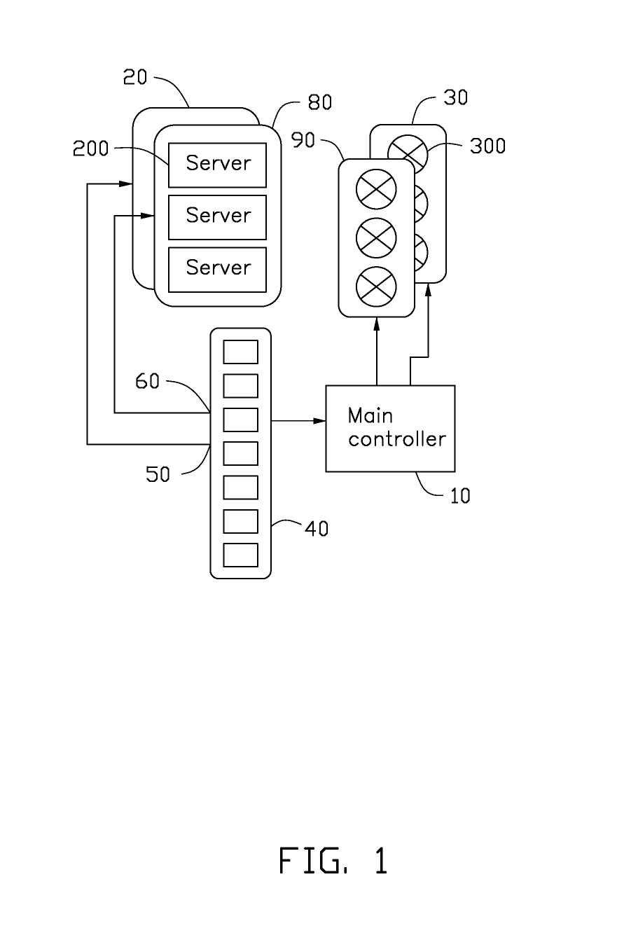

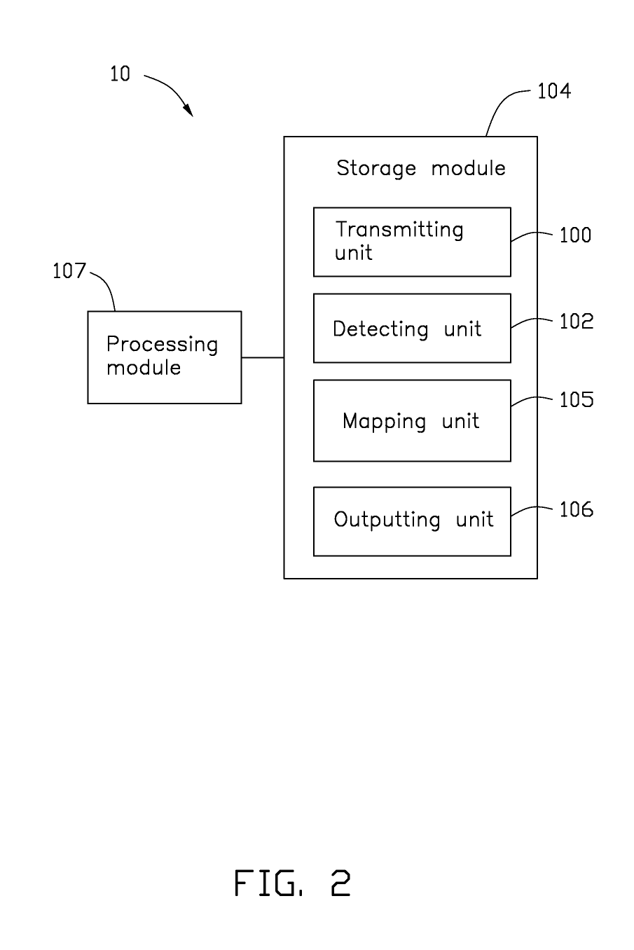

FIGS. 1 and 2 show an embodiment of a control system. The control system comprises a main controller 10, a plurality of fan modules, such as a first fan module 30 and a second fan module 90, a power distribution unit (PDU) 40, and a plurality of servers 200 located in a plurality of server cabinets, such as a first server cabinet 20 and a second server cabinet 80. The main controller 10 is electrically connected to the plurality of fan modules and the PDU 40. The PDU 40 is electrically connected to the plurality of servers 200. The main controller 10 comprises a processing module 107 and a storage module 104. The processing module 107 controls rotation speeds of the fan modules according to detected powers of the PDU 40, thereby dissipating heat generated by the plurality of servers 200. In the illustrated embodiment, each fan module comprises a plurality of fans 300. Each fan module is configured to dissipate heat generated by the servers 200 of one corresponding server cabinet 80. For example, the first fan module 30 is configured to dissipate heat generated by servers 200 of the first server cabinet 20, and the second fan module 90 is configured to dissipate heat generated by servers 200 of the second server cabinet 80.

The PDU 40 comprises a plurality of power-output terminals, such as a first power-output terminal 50 and a second power-output terminal 60. The PDU 40 outputs corresponding power to the first and second server cabinets 20 and 80 through the first and second power-output terminals 50 and 60, respectively.

The processing module 107 is coupled to the storage module 104. The storage module 104 stores a plurality of programs to be executed by the processing module 107. The storage module 104 stores a transmitting unit 100, a detecting unit 102, a mapping unit 105, and an outputting unit 106.

The transmitting unit 100 obtains power information that the PDU 40 outputs to the first and second server cabinets 20 and 80 through the first and second power-output terminals 50 and 60, respectively.

The mapping unit 105 comprises control information associated with the power information of the corresponding power-output terminals. For example, the mapping unit 105 comprises first control information associated with first power information of the first power-output terminal 50, second control information associated with second power information of the first power-output terminal 50, and third control information associated with third power information of the second power-output terminal 60.

The detecting unit 102 obtains the corresponding control information from the mapping unit 105 according to the power information. In the embodiment, the different control information corresponds to pulse width modulation (PWM) signals having different duty cycles.

The outputting unit 106 outputs the PWM signals to the fan modules to dissipate heat generated by the corresponding server cabinets.

For example, when the power detecting unit 102 obtains the first power information from the first power-output terminal 50, the power detecting unit 102 obtains the first control information from the mapping unit 105, and generates the PWM signal corresponding to the first control information. The outputting unit 106 outputs the PWM signal generated by the power detecting unit 102 to the first fan module 30.

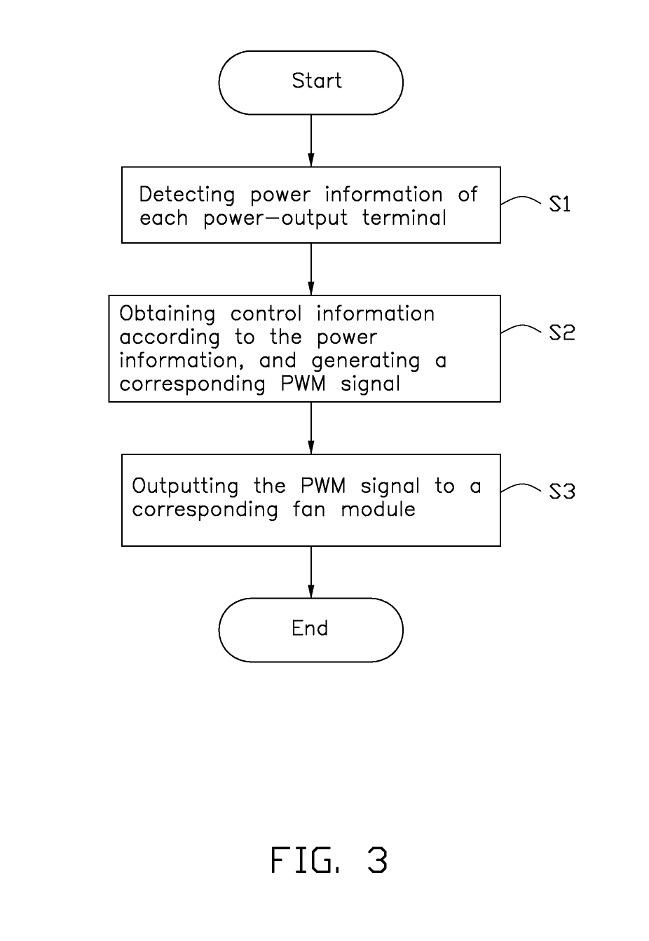

FIG. 3 shows an embodiment of a control method for fans. The control method comprises steps as described below.

In step S1, the detecting unit 102 detects the power outputted by each power-output terminal.

In step S2, the power detecting unit 102 obtains the corresponding control information from the mapping unit 105 according to the power information, and generates the PWM signal corresponding to the control information.

In step S3, the outputting unit 106 outputs the PWM signal generated by the power detecting unit 102 to the corresponding fan module.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control system, comprising:
a plurality of servers;
a plurality of fan modules each configured to dissipate heat generated by one or more servers;
a power distribution unit (PDU) comprising a plurality of power-output terminals providing power for the one or more servers; and
a main controller comprising:
a processing module; and a storage module coupled to the processing module, and comprising a plurality of programs to be executed by the processing module, wherein the storage module comprises:
a transmitting unit obtaining detected power information of the plurality of power-output terminals;
a mapping unit storing control information in association with the power information of each power-output terminal;
a detecting unit obtaining corresponding control information from the mapping unit according to the power information, and generating a pulse width modulation (PWM) signal corresponding to the control information; and
an outputting unit outputting the PWM signal generated by the power detecting unit to the corresponding fan module.

2. The control system of claim 1, wherein the power detecting unit generates the PWM signal with different duty cycle.

3. A control method, comprising:
obtaining power information of a plurality of power-output terminals of a power distribution unit (PDU);
obtaining corresponding control information from a mapping unit according to the power information, wherein the mapping unit stores control information in association with power information of the corresponding power-output terminal;
generating a pulse width modulation (PWM) signal corresponding to the control information; and;
outputting the PWM signal to a corresponding fan module.

4. The control method of claim 3, wherein the PWM signal has different duty cycle.
